(19) United States
(12) Patent Application Publication
(10) Pub. No.: US 2019/0080323 A1
(43) Pub. Date: Mar. 14, 2019

(54) MOBILE PAYMENT SYSTEM, MOBILE PAYMENT METHOD, AND MOBILE PAYMENT CONFIRMATION DEVICE

(71) Applicant: WayGO Financial Technology Co., Taipei City (TW)

(72) Inventor: SHIH-JIEH HSU, Taipei City (TW)

(21) Appl. No.: 16/130,647

(22) Filed: Sep. 13, 2018

(30) Foreign Application Priority Data
Sep. 14, 2017 (TW) 106131540

(51) Int. Cl. G06Q 20/40; G06Q 20/32

(52) U.S. Cl. CPC G06Q 20/401; G06Q 20/327

(57) ABSTRACT

The invention provides a mobile payment system, mobile payment method, and mobile payment confirmation device. The mobile payment system comprises at least one mobile payment confirmation device, a mobile communication device, and a payment service platform. The mobile payment confirmation device broadcasts a shop token. The mobile communication device starts a payment application program to receive the shop token, inputs a payment amount, and sends a payment transaction message including the shop token, a user token, and the payment amount to the payment service platform. The payment service platform executes a payment transaction process to obtain a payment transaction result, and send the payment transaction result to the mobile communication device. Afterwards, the mobile payment confirmation device receives the payment transaction result from the mobile communication device in the way of short distance communication, and appears the payment transaction result.

This non-provisional application claims priority claim under 35 U.S.C. § 119 (a) on Taiwan Patent Application No. 106131540 filed Sep. 14, 2017, the entire contents of which are incorporated herein by reference.

### FIELD OF THE INVENTION

The present invention relates to a payment system, payment method and payment confirmation device, more particularly, to a system, method and confirmation device for supporting mobile payment.

### BACKGROUND

In the past, most consumers pay in cash. However, with advances in technology, the payment by a way of non-cash is becoming more and more commonplace. For example, the payment is able to be implemented by physical credit card, digital credit card (Apple Pay/Android Pay), or mobile payment.

In recent years, many businesses have provided a service for mobile payment because the quick development of mobile communication devices (such as smart phones). Consumers can pay each of spendings by the way of mobile payment in the case of not using cash, physical credit card or digital credit card. Before a consumer wants to use a mobile payment service, his mobile communication device must install a specific payment application program provided by a mobile payment service businessman or a financial payment unit, so as to pay for spending by the use of this specific payment application program.

Moreover, the existing mobile payment loop is a closed payment loop. When a consumer consumes at A shop, the consumer must pay using a specific payment application program provided by the mobile payment service businessman or the financial payment unit, which is cooperated with A shop. Taking WeChat Pay and Alipay as examples, WeChat Pay and Alipay are two most commonly used mobile payments in current China consumer market. If A shop is only cooperated with WeChat Pay, the consumers can only use the payment application program provided by WeChat pay to execute the mobile payment, the mobile payment service provided by Alipay is unable to be applied in A shop. Accordingly, the consumers can only install the corresponding payment application program into his mobile communication device according to the mobile payment service businessman or the financial payment unit cooperated with the shop.

Besides, the shop must configure an electronic device capable of connecting network (such as a computer or POS device) when consumers pay by credit card (physical credit card or digital credit card) or mobile payment. The shop obtains the transaction authorization or payment confirmation by the electronic device connecting the financial transaction center (such as National Credit Card Center or financial payment unit). In order to provide the service of the credit card payment or mobile payment, the shop will increase a lot of costs for hardware or network connecting.

For the above reason, the present invention provides an innovative mobile payment manner, which will provide an opened payment loop. Customers can self-select the payment application program provided by any mobile payment service businessman or financial payment unit to execute the mobile payment, while the shop can confirm the transaction of mobile payment by a payment confirmation device that is without connecting network and a lower price, which is the object to be achieved by the present invention.

### SUMMARY

It is one objective of the present invention to provide a mobile payment system, which is provided with an opened payment loop, consumers can self-select a payment application program provided by any of financial payment units to execute a mobile payment, in such a way that consumer can pay to a shop without going through the financial payment unit cooperated with the shop to increase the convenience in mobile payments.

It is another objective of the present invention to provide a mobile payment system, which comprises a mobile payment confirmation device, a mobile communication device, and a payment service platform. The mobile payment confirmation device is having a short distance communication function, and configured in a shop. The mobile communication device is held by a consumer. When the consumer desires to pay in a way of mobile payment, he can request the payment service platform to execute a mobile payment process by the payment application program installed in the mobile communication device, so as to obtain a payment transaction result. The mobile communication device sends the payment transaction result to the mobile payment confirmation device in a way of short distance communication. The personnel of shop determines whether the consumer pays or the amount paid by the customer is correct by a payment amount and/or a transaction serial number of the payment transaction result appeared on the display unit. Accordingly, when the consumer completes the payment in the way of mobile payment, the shop can immediately confirm the transaction by the mobile payment confirmation device 10 that is no requiring to connect network, simple structure, and a lower price, so as to reduce the operational cost.

To achieve the above object, the present invention provides a mobile payment system, comprising: at least one mobile payment confirmation device comprising a controller, a first short distance communication module, and a display unit, and configured with a shop token, wherein the controller is connected to the first short distance communication module and the display unit, and broadcasts the shop token by the first short distance communication module; a mobile communication device comprising a processor, a second short distance communication module, a network communication module, a storage module, and a touch screen, wherein the processor is connected to the second short distance communication module, the network communication module, the storage module, and the touch screen, the storage module stores at least one payment application program and at least one user token, the mobile communication device is connected to the first short distance communication module of the mobile payment confirmation device by the second short distance communication module, wherein an operation frame of the payment application program is appeared on the touch screen when the payment application program starts; and a payment service platform comprising a user database and a shop database, wherein the user database stores a plurality of user payment account numbers, the shop database stores a plurality of shop shroff account numbers, the mobile communication device is connected to the payment service platform by the network communication module; when the payment application program of the mobile communication device starts, the mobile communication device receives the shop token broadcasted by the mobile payment confirmation device, user of the mobile communication device inputs a payment amount by the operation frame of the payment application program, the payment application program sends a payment transaction message including the shop token, the user token, and the payment amount to the payment service platform, the payment service platform executes a payment transaction process according to the payment transaction message to obtain a payment transaction result, and sends the payment transaction result to the mobile communication device; further, the mobile communication device sends the payment transaction result to the mobile payment confirmation device; then, the payment transaction result is appeared on the display unit of the mobile payment confirmation device.

In one embodiment of the present invention, the payment service platform searches out the corresponding shop shroff account number from the shop database according to the shop token in the payment transaction message, and searches out the corresponding user payment account number from the user database according to the user token in the payment transaction message, the payment service platform executes the payment transaction process according to the searched out of shop shroff account number, the searched out of user account number, and the payment amount to obtain the payment transaction result.

In one embodiment of the present invention, the mobile payment confirmation device is further configured with a shop name, encodes the shop name and the shop token to generate a shop identification code, and broadcasts the shop identification code by the first short distance communication module, the mobile communication device receives the shop identification code by the second short distance communication module, and decodes the shop identification code to obtain the shop name and the shop token, the shop name is appeared on the operation frame of the payment application program of the mobile communication device, the user of the mobile communication device, via the operation frame of the payment application program, clicks the shop name to be paid and inputs the payment amount, the payment application program integrates the clicked shop name, the shop token corresponding to the clicked shop name, the user token, and the payment amount into the payment transaction message.

In one embodiment of the present invention, the mobile payment confirmation device comprises an encoder connected to the controller, the encoder encodes the shop name and the shop token into the shop identification code, the mobile communication device comprises a decoder connected to the processor, the decoder decodes the shop identification code to obtain the shop name and the shop token.

In one embodiment of the present invention, the payment transaction result comprises a transaction serial number or the payment amount, the transaction serial number or the payment amount can be appeared on the display unit of the mobile payment confirmation device.

In one embodiment of the present invention, the mobile payment confirmation device comprises a first encryption and decryption unit connected to the controller, the mobile communication device comprises a second encryption and decryption unit connected to the processor, the mobile communication device can encrypt the payment transaction result via the second encryption and decryption unit to obtain an encrypted payment transaction result, and sends the encrypted payment transaction result to the mobile payment confirmation device, the mobile payment confirmation device can decrypt the encrypted payment transaction result via the first encryption and decryption unit to obtain the payment transaction result.

In one embodiment of the present invention, the first short distance communication module and the second short distance communication module are a Bluetooth communication module, respectively.

In one embodiment of the present invention, the network communication module is a 3G, 4G, or 5G communication module, a WiFi communication module, or a communication module capable of connecting network.

In one embodiment of the present invention, the user payment account number is a credit card number, a bank account number, an electronic wallet account number or an electronic payment account number.

In one embodiment of the present invention, the mobile payment system comprises a plurality of financial payment units, each of the financial payment units is provided with its own the payment application program, the user can self-select to install the payment application program, provided by one of the financial payment units, to the communication device, and generate the payment transaction message via the installed payment application program.

In one embodiment of the present invention, the shop database of the payment service platform further stores a plurality of shop shroff account lists, and the user database of the payment service platform further stores a plurality of user payment lists.

In one embodiment of the present invention, the payment service platform further comprises a computer module, a data comparison module, and a payment processing module, the computer module is connected to the data comparison module, the payment processing module, the shop database, and the user database, when the payment service platform receives the payment transaction message, it will execute the payment transaction process, the data comparison module searches out the corresponding shop shroff account number from the shop database according to the shop token in the payment transaction message, and searches out the corresponding user payment account number from the user database according to the user token in the payment transaction message, the payment processing module sends a payment request to a financial payment unit based on the searched out of shop shroff account number, the searched out of user account number, and the payment amount, the financial payment unit will send the payment transaction result to the payment service platform after it approves the payment request.

The present invention further provides a mobile payment method, which is applied in a mobile payment system, wherein the mobile payment system comprises at least one mobile payment confirmation device, a mobile communication device, and a payment service platform, steps of the mobile payment method comprising: configuring a shop token into the mobile payment confirmation device; storing a user token to the mobile communication device; broadcasting the shop token by a first short distance communication module of the mobile payment confirmation device; starting a payment application program of the mobile communication device to receive the shop token of the mobile payment confirmation device by a second short distance communication module of the mobile communication device; inputting a payment amount by the payment application program of the mobile communication device; sending a payment transaction message including the shop token, the user token, and the payment amount to the payment service platform by the payment application program; executing a payment transaction process by the payment service platform according to the payment transaction message to obtain a payment transaction result; sending the payment transaction result to the mobile communication device by the payment service platform; sending the payment transaction result to the mobile payment confirmation device by the second short distance communication module of the mobile communication device in a way of short distance communication; and appearing the payment transaction result on a display unit of the mobile payment confirmation device.

In one embodiment of the present invention, the steps of the mobile payment method further comprising: searching out a shop shroff account number from a shop database by the payment service platform according to the shop token in the payment transaction message; searches out a user payment account number from a user database by the payment service platform according to the user token in the payment transaction message; and executing the payment transaction process by the payment service platform based on the shop shroff account number, the user payment account number, and the payment amount to obtain the payment transaction result.

In one embodiment of the present invention, the steps of the mobile payment method further comprising: configuring a shop name into the mobile payment confirmation device; encoding the shop name and the shop token to generate a shop identification code by an encoder of the mobile payment confirmation device and broadcasting the shop identification code by the first short distance communication module of the mobile payment confirmation device; receiving the shop identification code of the mobile payment confirmation device by the second short distance communication module of the mobile communication device; decoding the shop identification code by a decoder of the mobile communication device to obtain the shop name and the shop token; appearing the shop name in an operation frame of the payment application program of the mobile communication device; and clicking the shop name to be paid and inputting the payment amount by the operation frame of the payment application program of the mobile communication device.

In one embodiment of the present invention, the steps of the mobile payment method further comprising: encrypting the payment transaction result by a second encryption and decryption unit of the mobile communication device to obtain an encrypted payment transaction result; sending the encrypted payment transaction result to the mobile payment confirmation device by the mobile communication device in the way of short distance communication; and decrypt the encrypted payment transaction result by a first encryption and decryption unit of the mobile payment confirmation device to obtain the payment transaction result.

In one embodiment of the present invention, the steps of the payment transaction process comprising: sending a payment request to a financial payment unit by the payment service platform based on the shop shroff account number, the user account number, and the payment amount; and sending the payment transaction result to the payment service platform by the financial payment unit after it approves the payment request.

The present invention further provides a mobile payment confirmation device, comprising: a controller configured with a shop token; a first short distance communication module connected to the controller, wherein the controller is connected to the first short distance communication module, and broadcasts the shop token and receives a payment transaction result by the first short distance communication module; and a display unit, connected to the controller, used for appearing the payment transaction result.

### BRIEF DESCRIPTION OF THE DRAWINGS

FIG. 1 is a system structural diagram of a mobile payment system according to one embodiment of the present invention.

FIG. 2 is a circuit structural diagram of a mobile payment confirmation device according to one embodiment of the present invention.

FIG. 3 is a circuit structural diagram of a mobile communication device according to one embodiment of the present invention

FIG. 4 is a circuit structural diagram of a payment service platform according to one embodiment of the present invention.

FIG. 5 is an operation frame of a payment application program of the mobile communication device according to one embodiment of the present invention.

FIG. 6 is a system structural diagram of a mobile payment system according to another embodiment of the present invention.

FIG. 7 is a circuit structural diagram of a mobile payment confirmation device according to another embodiment of the present invention.

FIG. 8 is a circuit structural diagram of a mobile communication device according to another embodiment of the present invention

FIG. 9 is a circuit structural diagram of a payment service platform according to another embodiment of the present invention.

### DETAILED DESCRIPTION OF THE PREFERRED EMBODIMENTS

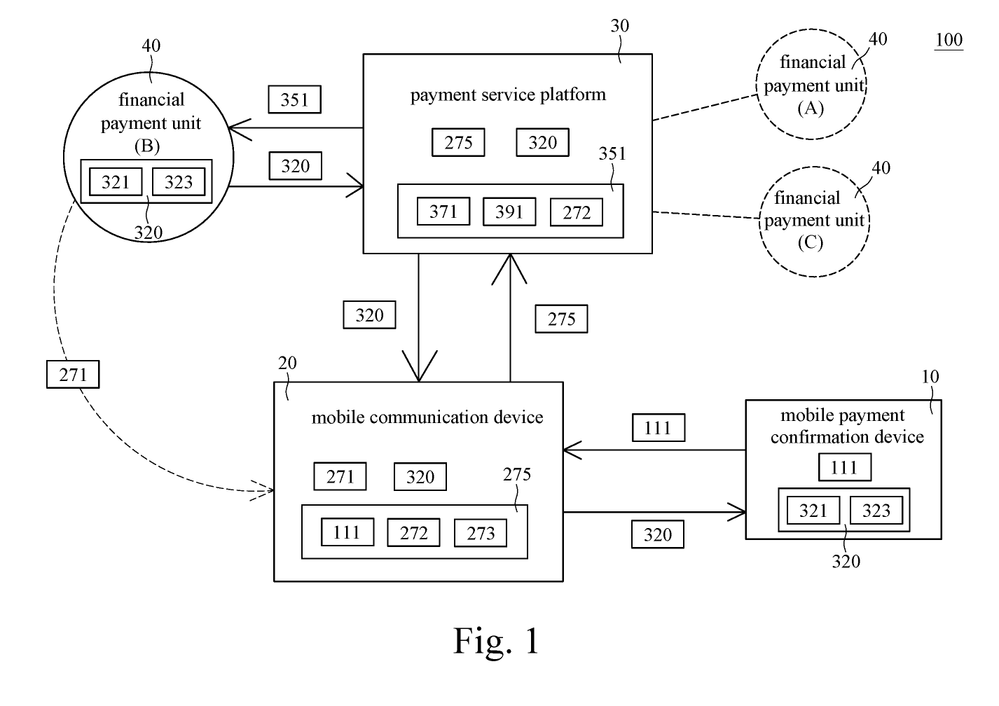

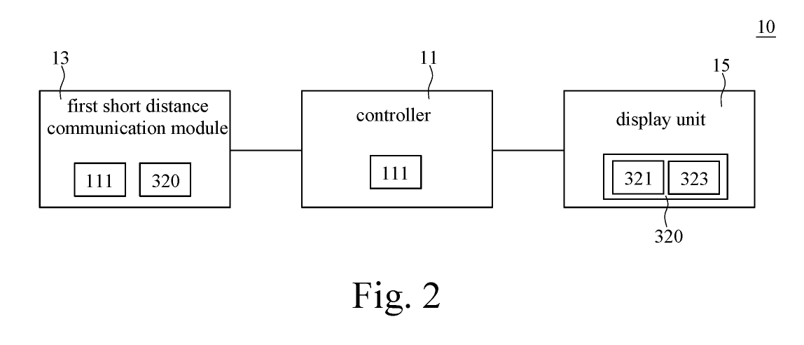

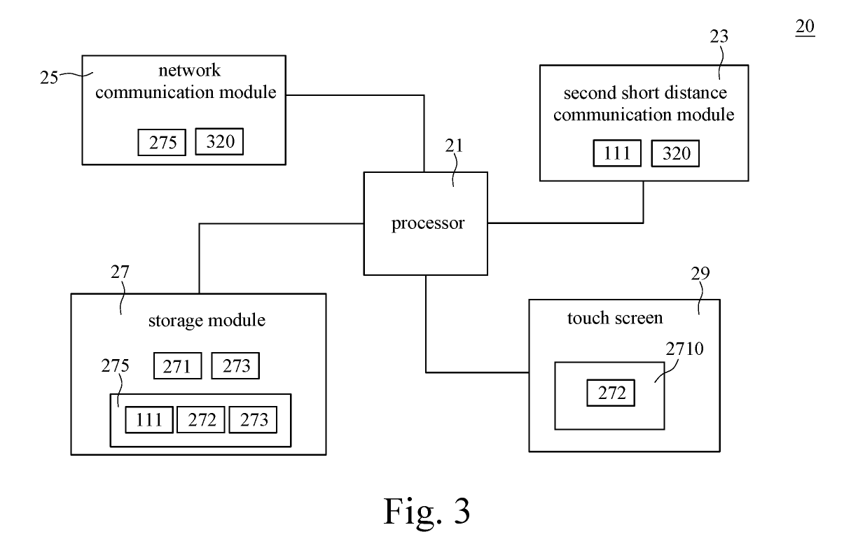

Referring to FIGS. 1, 2, 3, and 4, there are shown a system structural diagram of a mobile payment system according to one embodiment of the present invention, a circuit structural diagram of a mobile payment confirmation device according to one embodiment of the present invention, a circuit structural diagram of mobile communication device according to one embodiment of the present invention, and a circuit structural diagram of a payment service platform according to one embodiment of the present invention. As shown in FIGS. 1, 2, 3, and 4, the mobile payment system 100 of the present invention is used for providing a service for mobile payment, and comprises at least one mobile payment confirmation device 10, a mobile communication device 20, and a payment service platform 30.

Firstly, the mobile payment confirmation device 10 is a miniaturized device, and configured in a shop. The mobile payment confirmation device 10 comprises a controller 11, a first short distance communication module 13, and a display unit 15. The mobile payment confirmation device 10 is configured with a shop token 111. The shop token is stored in a memory element, for example, ROM, of the controller 11. The display unit 15 is a small display, for example, LED display panel. The controller 11 broadcasts the shop token 111 by the first short distance communication module 13.

In the present invention, the mobile communication device 20 is held by a user whose can be a consumer. The mobile communication device 20 comprises a processor 21, a second short distance communication module 23, a network communication module 25, a storage module 27, and a touch screen 29. The processor 21 is connected to the second short distance communication module 23, the network communication module 25, the storage module 27, and the touch screen 29. The storage module 27 stores at least one payment application program 271 and at least one user token 273. The mobile communication device 20 is connected to the first short distance communication module 13 of the mobile payment confirmation device 10 by the second short distance communication module 23. In one embodiment of the present invention, the first short distance communication module 13 and the second short distance communication module 23 are a Bluetooth communication module, or other communication modules conforming to short distance communication specification, respectively.

The payment service platform 30 is a server capable of performing a payment processing. The mobile communication device 20 is connected to the payment service platform 30 by the network communication module 25. In one embodiment of the present invention, the network communication module 25 is a 3G, 4G, or 5G communication module, a WiFi communication module, or a communication module capable of connecting network.

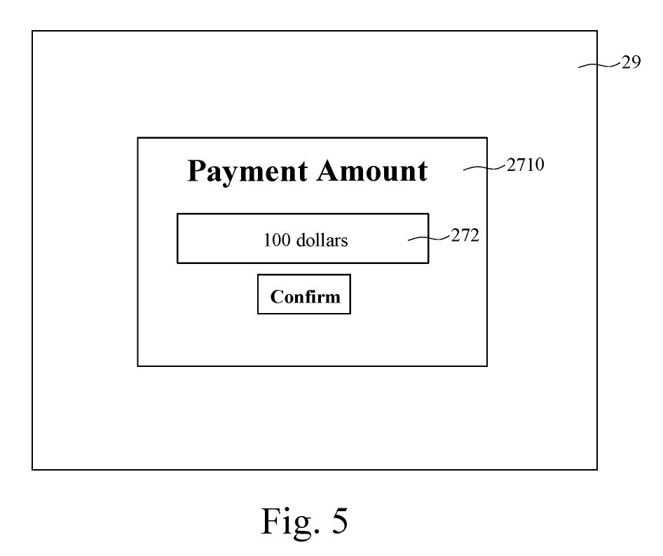

The mobile payment confirmation device 10 broadcasts the shop token 111 by the first short distance communication module 13. When the consumer desires to pay money in a way of mobile payment, he can start the payment application program 271 of the mobile communication device 20, an operation frame 2710 of the payment application program 271 will be appeared on the touch screen 29. When the mobile communication device 20 approaches the mobile payment confirmation device 10, the second short distance communication module 23 of the mobile communication device 20 will receive the shop token 111 broadcasted from the mobile payment confirmation device 10 in a way of short distance communication. After the mobile communication device 20 receives the shop token 111, the user inputs a payment amount 272 by the operation frame 2710 of the payment application program 271, as shown in FIG. 5. Then, the payment application program 271 sends a payment transaction message 275 including the shop token 111, the user token 273, and the payment amount 272 to the payment service platform 30 by the network communication module 25. The payment service platform 30 executes a payment transaction process 301 according to the payment transaction message 275 to obtain a payment transaction result 320. In one embodiment of the present invention, the payment transaction result 320 comprises a payment amount 321 and/or a transaction serial number 323. After the payment transaction succeeds, the mobile communication device 20 receives the payment transaction result 320 from the payment service platform 30 in a way of network communication, and sends the payment transaction result 320 to the mobile payment confirmation device 10 in the way of short distance communication.

Further, the payment service platform 30 comprises a computer module 31, a data comparison module 33, and a payment processing module 35, a shop database 37, and a user database 39. The computer module 31 is connected to the data comparison module 33, the payment processing module 35, the shop database 37, and the user database 39. The shop database 37 stores a plurality of shop shroff account numbers 371, and the user database 39 stores a plurality of user payment account numbers 391. When the payment service platform 30 receives the payment transaction message 275, the computer module 31 will control the data comparison module 33 and the payment processing module 35 to execute the payment transaction process 301. During the execution of the payment transaction process 301, the data comparison module 33 searches out a corresponding shop shroff account number 371 from the shop database 37 according to the shop token 111 in the payment transaction message 275, and searches out a corresponding user payment account number 391 from the user database 39 according to the user token 273 in the payment transaction message 275. During the execution of the payment transaction process 301, the payment processing module 35 sends a payment request 351 to a financial payment unit 40 according to the searched out of shop shroff account number 371, the searched out of user account number 391, and the payment amount 272. In one embodiment of the present invention, the user account number 391 is a credit card data, a bank account number, an electronic wallet account or an electronic payment account, and the financial payment unit 40 is a bank or a third party payment company. The financial payment unit 40 will send the payment transaction result 320 to the payment service platform 30 after it approves the payment request 351. Afterwards, the mobile communication device 20 receives the payment transaction result 320 from the payment service platform 30 in the way of network communication, and sends the payment transaction result 320 to the mobile payment confirmation device 10 in the way of short distance communication.

After the mobile payment confirmation device 10 receives the payment transaction result 320 from the mobile communication device 20, the payment transaction result 320 is appeared on the display unit 15. Thus, the personnel of shop determines whether the consumer pays or the amount paid by the customer is correct by a payment amount 321 and/or a transaction serial number 323 of the payment transaction result 320 appeared on the display unit 15. Accordingly, when the consumer completes the payment in the way of mobile payment, the shop providing the mobile payment service can immediately confirm the mobile payment transaction by the mobile payment confirmation device 10 that is no requiring to connect network, simple structure, and a lower price, so as to reduce the operational cost.

The shop database 37 of the payment service platform 30 further stores a plurality of shop shroff account lists 373, and the user database 39 further stores a plurality of user payment lists 393. The customer or the shop can login the payment service platform 30 by any computer device or communication device to query own payment lists 393 or shroff account lists 373.

The payment application program 271 of the mobile communication device 20 of the present invention is provided by the financial payment unit 40. The customer of the present invention can self-select the payment application program 271 provided by any mobile payment service businessman or financial payment unit to execute the mobile payment. For example, the financial payment unit (B) 40 is customer's correspondent bank, the customer may select to install the payment application program 271 provided by the financial payment unit (B) 40 in his own mobile communication device 20, and use the payment application program 271 provided by the financial payment unit (B) 40 to perform the mobile payment. Thus, when the payment service platform 30 receives the payment transaction message 275 sent from the mobile communication device 20, it will make a payment request 351 to the financial payment unit (B) 40 so as to pay to the shop through the financial payment unit (B) 40.

Accordingly, the mobile payment system 100 of the present invention provides a opened payment loop, the consumer can self-decide to install the payment application program 271 provided by any of financial payment units 40 in his own mobile communication device 20 according to his own actual situation, in such a way that consumers can pay money to the shop without going through the financial payment unit cooperated with shop to increase the convenience in mobile payments.

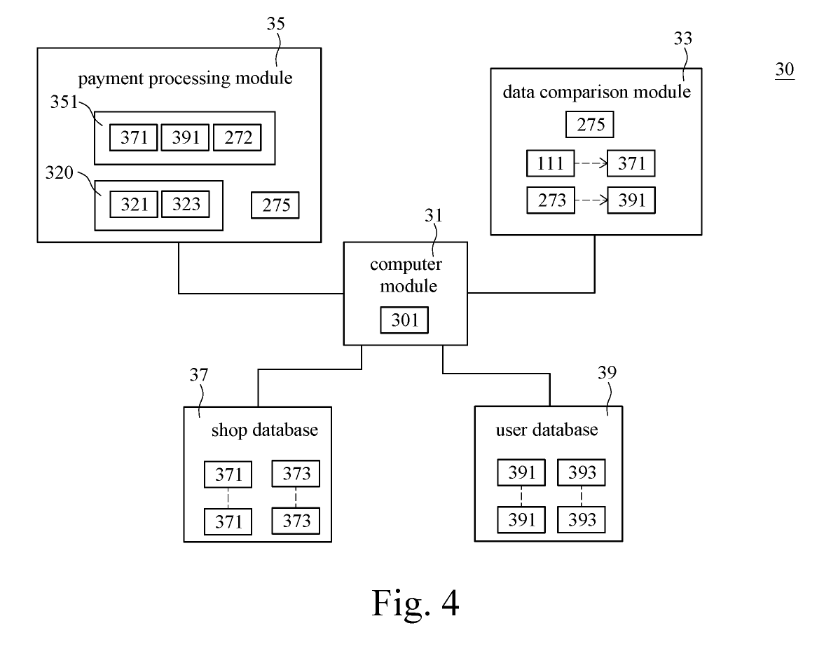

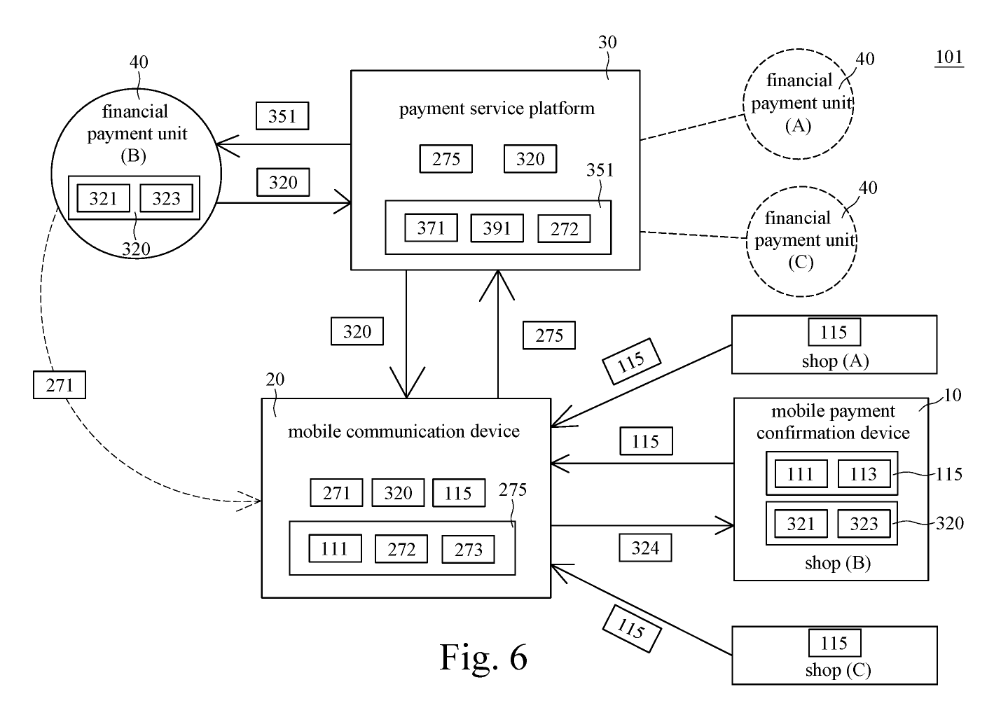

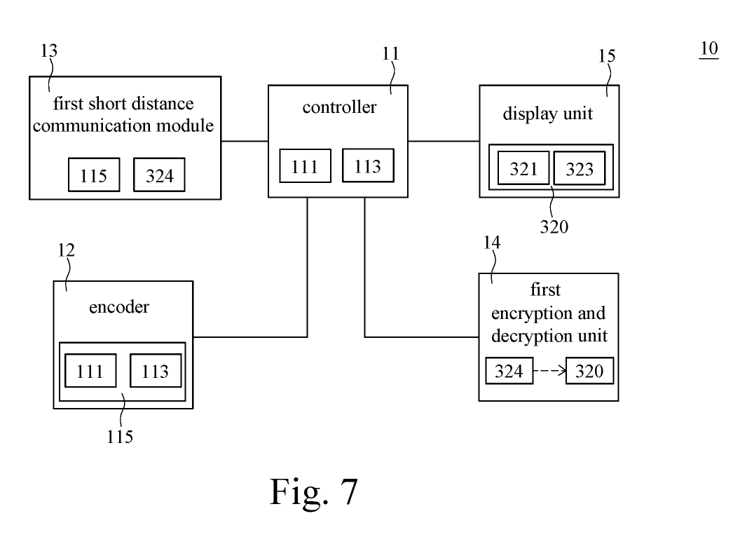

Referring to FIGS. 6, 7, and 8, there are shown a system structural diagram of a mobile payment system according to another embodiment of the present invention, a circuit structural diagram of a mobile payment confirmation device according to another embodiment of the present invention, a circuit structural diagram of mobile communication device according to another one embodiment of the present invention, as well as simultaneous referring to FIG. 4. As shown in FIGS. 6 and 7, in the mobile payment system 101 of the present embodiment, the mobile payment confirmation device 10 is further configured with a shop name 113. The shop name 113 is able to be stored in the memory element (such ROM) of the controller 11. The mobile payment confirmation device 10 further comprises an encoder 12 connected to the controller 11. The encoder 12 encodes the shop token 111 and the shop name 113 to generate a shop identification code 115, and the controller 11 broadcasts the shop identification code 115 via the first short distance communication module 13.

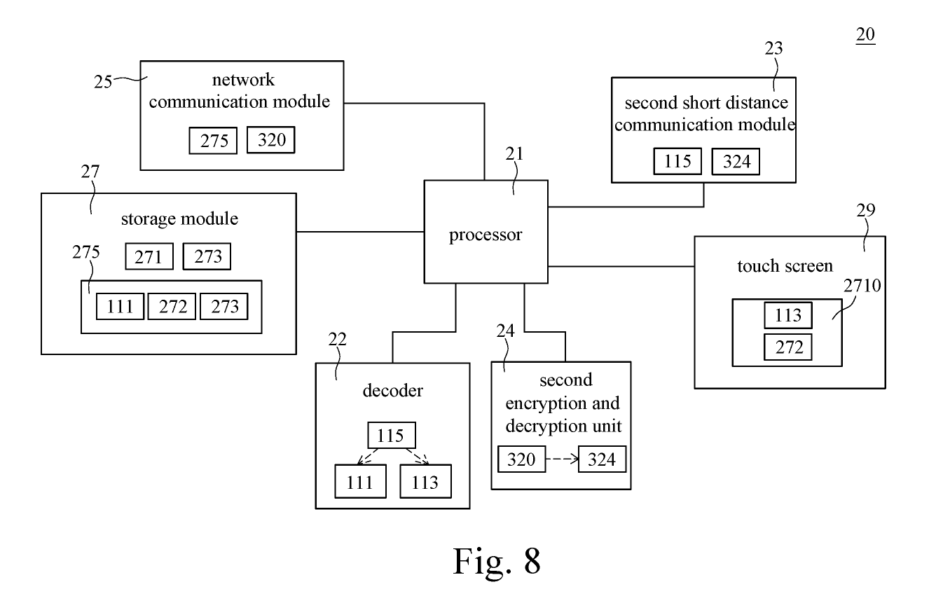

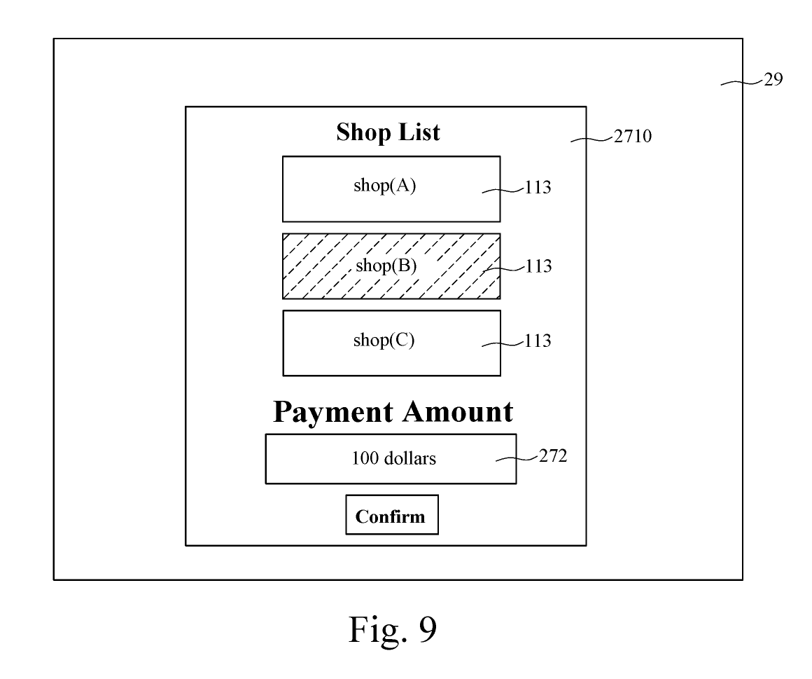

As shown in FIGS. 6 and 8, the mobile communication device 20 comprises a decoder 22 connected to the processor 21. The decoder 22 decodes the shop identification code 115 to obtain the shop token 111 and the shop name 113. In the present embodiment, when the consumer desires to pay money in the way of mobile payment, he can starts the payment application program 271 of the mobile communication device 20, the payment application program 271 of the mobile communication device 20 will scan each of payment confirmation devices 10 in the vicinity to receive each of the shop identification codes 115 broadcasted by each of payment confirmation devices 10, and the decoder 22 of the mobile communication device 20 can decode each of the shop identification codes 115 to obtain each of shop tokens 111 and each of shop names 113. As shown in FIG. 9, each of shop names 113 will be appeared on the operation frame 2710 of the payment application program 271 of the mobile communication device 20. For example, shops (A), (B), and (C) are appeared on the operation frame 2710 of the payment application program 271 of the mobile communication device 20. The customer selects one of those shop names 113 to be paid and inputs the payment amount 272 by clicking the operation frame 2710 of the payment application program 271, for example, the shop (B) is selected and 100 dollars are inputted. The payment application program 271 will integrate the shop token 111 corresponding to the shop (B), the user token 273, and the payment amount 272 into a payment transaction message 275, and send the payment transaction message 275 to the payment service platform 30. After the payment service platform 30 receives the payment transaction message 275, it will execute the payment transaction process 301 to obtain the payment transaction result 320, and send the payment transaction result 320 to the mobile communication device 20.

As shown in FIGS. 7 and 8, the mobile payment confirmation device 10 of the present embodiment further comprises a first encryption and decryption unit 14 connected to the controller 11, and the mobile communication device 20 of the present embodiment further comprises a second encryption and decryption unit 24 connected to the processor 21. The first encryption and decryption unit 14 and the second encryption and decryption unit 24 are an asymmetric encryption and decryption algorithm unit, respectively. The first encryption and decryption unit 14 and the second encryption and decryption unit 24 can be configured in the payment confirmation device 10 and the mobile communication device 20 in a firmware type or a hardware type, respectively. When the mobile communication device 20 receives the payment transaction result 320, it will encrypt the payment transaction result 320 via the second encryption and decryption unit 24 to obtain an encrypted payment transaction result 324, and sends the encrypted payment transaction result 324 to the mobile payment confirmation device 10. Afterwards, the mobile payment confirmation device 10 can decrypt the encrypted payment transaction result 324 via the first encryption and decryption unit 14 to obtain the payment transaction result 320.

Accordingly, the mobile payment system 201 of the present invention is configured an encoding mechanism and an encryption mechanism between the mobile payment confirmation device 10 and the mobile communication device 20 in such a way that the signals transmitted between the mobile payment confirmation device 10 and the mobile communication device 20 can be protected by encoding or encrypting, to ensure the safety in the mobile payment of consumers.

The above disclosure is only the preferred embodiment of the present invention, and not used for limiting the scope of the present invention. All equivalent variations and modifications on the basis of shapes, structures, features and spirits described in claims of the present invention should be included in the claims of the present invention.

1. A mobile payment system, comprising:
at least one mobile payment confirmation device comprising a controller, a first short distance communication module, and a display unit, and configured with a shop token, wherein the controller is connected to the first short distance communication module and the display unit, and broadcasts the shop token by the first short distance communication module;
a mobile communication device comprising a processor, a second short distance communication module, a network communication module, a storage module, and a touch screen, wherein the processor is connected to the second short distance communication module, the network communication module, the storage module, and the touch screen, the storage module stores at least one payment application program and at least one user token, the mobile communication device is connected to the first short distance communication module of the mobile payment confirmation device by the second short distance communication module, wherein an operation frame of the payment application program is appeared on the touch screen when the payment application program starts; and
a payment service platform comprising a user database and a shop database, wherein the user database stores a plurality of user payment account numbers, the shop database stores a plurality of shop shroff account numbers, the mobile communication device is connected to the payment service platform by the network communication module;
when the payment application program of the mobile communication device starts, the mobile communication device receives the shop token broadcasted by the mobile payment confirmation device, user of the mobile communication device inputs a payment amount by the operation frame of the payment application program, the payment application program sends a payment transaction message including the shop token, the user token, and the payment amount to the payment service platform, the payment service platform executes a payment transaction process according to the payment transaction message to obtain a payment transaction result, and sends the payment transaction result to the mobile communication device; further, the mobile communication device sends the payment transaction result to the mobile payment confirmation device; then, the payment transaction result is appeared on the display unit of the mobile payment confirmation device.

2. The mobile payment system according to claim 1, wherein the payment service platform searches out the corresponding shop shroff account number from the shop database according to the shop token in the payment transaction message, and searches out the corresponding user payment account number from the user database according to the user token in the payment transaction message, the payment service platform executes the payment transaction process according to the searched out of shop shroff account number, the searched out of user account number, and the payment amount to obtain the payment transaction result.

3. The mobile payment system according to claim 1, wherein the mobile payment confirmation device is further configured with a shop name, encodes the shop name and the shop token to generate a shop identification code, and broadcasts the shop identification code by the first short distance communication module, the mobile communication device receives the shop identification code by the second short distance communication module, and decodes the shop identification code to obtain the shop name and the shop token, the shop name is appeared on the operation frame of the payment application program of the mobile communication device, the user of the mobile communication device, via the operation frame of the payment application program, clicks the shop name to be paid and inputs the payment amount, the payment application program integrates the clicked shop name, the shop token corresponding to the clicked shop name, the user token, and the payment amount into the payment transaction message.

4. The mobile payment system according to claim 3, wherein the mobile payment confirmation device comprises an encoder connected to the controller, the encoder encodes the shop name and the shop token into the shop identification code, the mobile communication device comprises a decoder connected to the processor, the decoder decodes the shop identification code to obtain the shop name and the shop token.

5. The mobile payment system according to claim 1, wherein the payment transaction result comprises a transaction serial number or the payment amount, the transaction serial number or the payment amount can be appeared on the display unit of the mobile payment confirmation device.

6. The mobile payment system according to claim 1, wherein the mobile payment confirmation device comprises a first encryption and decryption unit connected to the controller, the mobile communication device comprises a second encryption and decryption unit connected to the processor, the mobile communication device can encrypt the payment transaction result via the second encryption and decryption unit to obtain an encrypted payment transaction result, and sends the encrypted payment transaction result to the mobile payment confirmation device, the mobile payment confirmation device can decrypt the encrypted payment transaction result via the first encryption and decryption unit to obtain the payment transaction result.

7. The mobile payment system according to claim 1, wherein the first short distance communication module and the second short distance communication module are a Bluetooth communication module, respectively.

8. The mobile payment system according to claim 1, wherein the network communication module is a 3G, 4G, or 5G communication module, a WiFi communication module, or a communication module capable of connecting network.

9. The mobile payment system according to claim 1, wherein the user payment account number is a credit card number, a bank account number, an electronic wallet account number or an electronic payment account number.

10. The mobile payment system according to claim 1, the mobile payment system comprises a plurality of financial payment units, each of the financial payment units is provided with its own the payment application program, the user can self-select to install the payment application program, provided by one of the financial payment units, to the communication device, and generate the payment transaction message via the installed payment application program.

11. The mobile payment system according to claim 2, wherein the shop database of the payment service platform further stores a plurality of shop shroff account lists, and the user database of the payment service platform further stores a plurality of user payment lists.

12. The mobile payment system according to claim 2, wherein the payment service platform further comprises a computer module, a data comparison module, and a payment processing module, the computer module is connected to the data comparison module, the payment processing module, the shop database, and the user database, when the payment service platform receives the payment transaction message, it will execute the payment transaction process, the data comparison module searches out the corresponding shop shroff account number from the shop database according to the shop token in the payment transaction message, and searches out the corresponding user payment account number from the user database according to the user token in the payment transaction message, the payment processing module sends a payment request to a financial payment unit based on the searched out of shop shroff account number, the searched out of user account number, and the payment amount, the financial payment unit will send the payment transaction result to the payment service platform after it approves the payment request.

13. A mobile payment method, which is applied in a mobile payment system, wherein the mobile payment system comprises at least one mobile payment confirmation device, a mobile communication device, and a payment service platform, steps of the mobile payment method comprising:
configuring a shop token into the mobile payment confirmation device;
storing a user token to the mobile communication device;
broadcasting the shop token by a first short distance communication module of the mobile payment confirmation device;
starting a payment application program of the mobile communication device to receive the shop token of the mobile payment confirmation device by a second short distance communication module of the mobile communication device;
inputting a payment amount by the payment application program of the mobile communication device;
sending a payment transaction message including the shop token, the user token, and the payment amount to the payment service platform by the payment application program;
executing a payment transaction process by the payment service platform according to the payment transaction message to obtain a payment transaction result;
sending the payment transaction result to the mobile communication device by the payment service platform;
sending the payment transaction result to the mobile payment confirmation device by the second short distance communication module of the mobile communication device in a way of short distance communication; and
appearing the payment transaction result on a display unit of the mobile payment confirmation device.

14. The mobile payment method according to claim 13, the steps of the mobile payment method further comprising:
searching out a shop shroff account number from a shop database by the payment service platform according to the shop token in the payment transaction message;
searches out a user payment account number from a user database by the payment service platform according to the user token in the payment transaction message; and
executing the payment transaction process by the payment service platform based on the shop shroff account number, the user payment account number, and the payment amount to obtain the payment transaction result.

15. The mobile payment method according to claim 13, the steps of the mobile payment method further comprising:
configuring a shop name into the mobile payment confirmation device;
encoding the shop name and the shop token to generate a shop identification code by an encoder of the mobile payment confirmation device and broadcasting the shop identification code by the first short distance communication module of the mobile payment confirmation device;
receiving the shop identification code of the mobile payment confirmation device by the second short distance communication module of the mobile communication device;
decoding the shop identification code by a decoder of the mobile communication device to obtain the shop name and the shop token;
appearing the shop name in an operation frame of the payment application program of the mobile communication device; and
clicking the shop name to be paid and inputting the payment amount by the operation frame of the payment application program of the mobile communication device.

16. The mobile payment method according to claim 13, the steps of the mobile payment method further comprising:
encrypting the payment transaction result by a second encryption and decryption unit of the mobile communication device to obtain an encrypted payment transaction result;
sending the encrypted payment transaction result to the mobile payment confirmation device by the mobile communication device in the way of short distance communication; and
decrypt the encrypted payment transaction result by a first encryption and decryption unit of the mobile payment confirmation device to obtain the payment transaction result.

17. The mobile payment method according to claim 13, the steps of the payment transaction process comprising:
sending a payment request to a financial payment unit by the payment service platform based on the shop shroff account number, the user account number, and the payment amount; and
sending the payment transaction result to the payment service platform by the financial payment unit after it approves the payment request.

18. The mobile payment method according to claim 13, wherein the payment transaction result comprises a transaction serial number or the payment amount, the transaction serial number or the payment amount can be appeared on the display unit of the mobile payment confirmation device.

19. A mobile payment confirmation device, comprising:
a controller configured with a shop token;
a first short distance communication module connected to the controller, wherein the controller is connected to the first short distance communication module, and broadcasts the shop token and receives a payment transaction result by the first short distance communication module; and
a display unit, connected to the controller, used for appearing the payment transaction result.

20. The mobile payment confirmation device according to claim 19, wherein the controller is further configured with a shop name, encodes the shop name and the shop token to generate a shop identification code, and broadcasts the shop identification code by the first short distance communication module.

21. The mobile payment confirmation device according to claim 19, wherein the mobile payment confirmation device further comprises a first encryption and decryption unit connected to the controller, the controller receives an encrypted payment transaction result by the first short distance communication module, and decrypts the encrypted payment transaction result by the first encryption and decryption unit to obtain the payment transaction result.

22. The mobile payment confirmation device according to claim 19, wherein the first short distance communication module is a Bluetooth communication module.

23. The mobile payment confirmation device according to claim 19, wherein the payment transaction result comprises a transaction serial number or the payment amount, the transaction serial number or the payment amount can be appeared on the display unit of the mobile payment confirmation device.
